(19) United States
(12) Patent Application Publication
(10) Pub. No.: US 2014/0324662 A1
(43) Pub. Date: Oct. 30, 2014

(54) Systems and Methods for Trading Electrical Power

(71) Applicant: Open Access Technology International, Inc., Minneapolis, MN (US)

(72) Inventors: Ilya William Slutsker, Plymouth, MN (US); Sasan Mokhtari, Eden Prairie, MN (US); Solomon Lo, Brooklyn Center, MN (US); Carlos Gonzalez-Perez, Maple Grove, MN (US)

(73) Assignee: Open Access Technology International, Inc., Minneapolis, MN (US)

(21) Appl. No.: 14/216,163

(22) Filed: Mar. 17, 2014

Related U.S. Application Data
(60) Provisional application No. 61/791,175, filed on Mar. 15, 2013.

(51) Int. Cl. G06Q 50/06

(52) U.S. Cl. CPC G06Q 50/06; G06Q 40/04
USPC 705/37

(57) ABSTRACT

Systems and methods are provided, which facilitate the integration of energy trading, transmission management and scheduling. The systems and methods facilitate the posting of bids and offers to buy and sell energy or capacity, allow users to view the bids and offers of others, negotiate the details of bids and offers, and permit deal formation for the purchase and sale of bids and offers. The disclosure also facilitates issuing proposals and counteroffers to enter into deals for power transmission. The disclosure also enables the scheduling of transmission including facilitating communication with various other systems. The disclosed systems and methods further enable the creation, modification and storing of transmission paths for recall and then evaluation in the scheduling of transmission path. The systems and methods are linked to and receive input from various sources of data and may facilitate two way communication with other systems in order to enable certain functionality.

### CROSS-REFERENCE TO RELATED APPLICATIONS

This application claims priority to U.S. Provisional patent application No. 61/791,175 filed Mar. 15, 2013, the entire content of which is hereby incorporated by reference.

Applicant has other co-pending applications directed to the energy market, namely:

SYSTEMS AND METHODS FOR DEMAND RESPONSE AND DISTRIBUTED ENERGY RESOURCE MANAGEMENT, filed Feb. 9, 2011 and assigned application Ser. No. 13/024,158, the entire contents of which is hereby incorporated by reference.

AUTOMATION OF ENERGY TRADING, filed Dec. 30, 2011 and assigned application Ser. No. 13/140,248, the entire contents of which is hereby incorporated by reference.

CERTIFICATE INSTALLATION AND DELIVERY PROCESS, FOUR FACTOR AUTHENTICATION, AND APPLICATIONS UTILIZING SAME, filed Oct. 15, 2013 and assigned application Ser. No. 14/054,611, the entire contents of which is hereby incorporated by reference.

A renewable energy credit management system and method, filed Feb. 10, 2014 and assigned application Ser. No. 14/176,590, the entire contents of which is hereby incorporated by reference.

Systems and methods of determining optimal scheduling and dispatch of power resources, filed on Mar. 17, 2014 (Docket No. O17.2P-15315-US03), the entire contents of which is hereby incorporated by reference.

Systems and methods for managing energy generation and procurement, filed on Mar. 17, 2014 (Docket No. O17.2P-15469-US03), the entire contents of which is hereby incorporated by reference.

Systems and methods for tracing electrical energy of a load to a specific generator on a power grid, filed on Mar. 17, 2014 (Docket No. O17.2P-15493-US03), the entire contents of which is hereby incorporated by reference.

Systems and methods for managing conditional curtailment options, filed on Mar. 17, 2014 (Docket No. O17.2P-15571-US03), the entire contents of which is hereby incorporated by reference.

Systems and methods for tracking greenhouse gas emissions, filed on Mar. 17, 2014 (Docket No. O17.2P-15954-US02), the entire contents of which is hereby incorporated by reference.

Systems and methods for parameter estimation for use in determining value-at-risk, filed on Mar. 17, 2014 (Docket No. O17.2P-15955-US02), the entire contents of which is hereby incorporated by reference.

Systems and methods for managing transmission service reservations, filed on Mar. 17, 2014 (Docket No. O17.2P-15956-US02), the entire contents of which is hereby incorporated by reference.

Systems and methods for interfacing an electrical energy end user with a utility, filed on Mar. 17, 2014 (Docket No. O17.2P-15958-US02), the entire contents of which is hereby incorporated by reference.

Use of Demand Response (DR) and Distributed Energy Resources (DER) to mitigate the impact of Variable Energy Resources (VER) in Power System Operation, filed on Mar. 17, 2014 (Docket No. O17.2P-15959-US02), the entire contents of which is hereby incorporated by reference.

### STATEMENT REGARDING FEDERALLY SPONSORED RESEARCH

Not Applicable

### FIELD OF THE INVENTION

The present invention relates generally to electric power and, more particularly, to systems and methods for facilitating convenient, expedient and efficient electric power trading integrated with the functionality for the scheduling of electric power transmission.

### BACKGROUND OF THE INVENTION

Modern electrical power trading and scheduling have become multistep processes that place significant burdens on participants. The overhead of transmission and scheduling action often prevents fast scheduling in power markets today. Participants in a typical modern energy transaction require a number of coordinated and mutually dependent actions to procure and confirm the actions undertaken by buyers and sellers. Moreover, a transaction for electric energy cannot be scheduled until an OASIS transmission path suitable for each party is found and coordinated between the parties. This has typically required buyers and sellers to locate a transmission path with available capacity, purchase or confirm existing transmission rights along that path from various transmission providers, coordinate scheduling actions, create an electronic tag (e-Tag) that is compliant with industry rules and regulations, and submit such an e-Tag for approval. Historically, such communication has taken place over telephone calls, facsimile exchange and/or instant message communication utilizing various programs operating on various communication protocols. None of these communication options were particularly secure, expedient, or suitable for complex energy trading negotiations and scheduling.

### BRIEF SUMMARY OF THE INVENTION

In general, this disclosure is directed toward integrated trading, transmission management and scheduling systems and methods. Using the systems and methods described in this disclosure, electric energy trading inputs are integrated with both transmission and scheduling information for convenient display and cohesive user action, which facilitate the posting of bids and offers to buy and sell energy or capacity, allow a user to view bids and offers posted by others including details of such postings, facilitate negotiation between buyers and sellers on the details of bids and offers, and permit deal formation for the purchase/sale of posted bids and offers. Such methods and systems also facilitate issuing proposals with counteroffer terms, and entering deals created externally for scheduling of electric power transmission. The disclosure described herein further provides for systems and methods of manually or automatically creating, modifying and then saving transmission paths for quick and convenient single party evaluation of and then scheduling of electrical transmission for purchased energy.

In one example, this disclosure is directed to a system and method that receives Available Transmission Capability (ATC) prices and ATC offerings from Open Access Same time Information System (OASIS) nodes, and a data feed of Transmission Service Requests (TSRs) and communicates with electronic tagging systems to create electronic tags (e-Tags) all in order to facilitate a market for the posting of electrical energy bids and offers amongst a group of entities which facilitates both anonymous discussions of deals between the counterparties and negotiation of deals before proceeding to an agreed upon transaction for electric energy and further, whereupon the scheduling for transmission of the electric energy subject to the transaction is then facilitated in an integrated and conveniently straightforward manner along a transmission path as evaluated and then selected by a single party or both parties to the energy transaction.

In at least one embodiment, this disclosure is directed to a computer program for use with a graphics display device, the computer program comprising a computer usable medium having computer readable program code means embodied in the medium for facilitating the systems and methods described herein, more specifically computer program code for the input of data, posting of energy bids and offers, review of bids and offers, facilitation of deal communication, facilitation of deal negotiation, deal capture, transmission evaluation, transmission scheduling, and e-tag submission.

The invention may take the form of a system for the trading, transmission management and scheduling of electric energy, configured to:
Receive input data comprised of OASIS registry data, TSR data, electric energy registry data, ATC prices, ATC offerings, e-tag templates, deal automation templates, and transmission portfolio data;
Allow for the posting of bids and offers for electric capacity;
Facilitate the review of posted bids and offers;
Permit counterparty communication;
Facilitate deal negotiation;
Facilitate deal acceptance;
Facilitate the evaluation of energy scheduling;
Format schedule information for delivery to transmission scheduling systems;
Integrate with and send schedule information to scheduling systems;
Format deal information;
Integrate with and send deal information to various other systems;
Generation and submission of e-Tag.

The invention may also include a method for the trading, transmission management and scheduling of electric energy by:
Receiving input data comprised of OASIS registry data, TSR data, electric energy registry data, ATC prices, ATC offerings, e-tag templates, deal automation templates, and transmission portfolio data;
Creating and posting bids and offers for electric energy and capacity;
Reviewing posted bids and offers;
Communicating with counterparty;
Negotiating a deal;
Accepting a deal;
Evaluating options for energy transmission and scheduling;
Selecting an option for energy transmission and scheduling;
Formatting selected energy transmission and scheduling data for delivery to OASIS Notes and scheduling systems;
Integration with and delivery of energy transmission and scheduling schedule information to various other systems;
Formatting deal information;
Integration with and delivery of deal information to various other systems;
Creation of e-Tag.

The details of one or more aspects of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating a particular embodiment of the disclosure

FIG. 2 is a block diagram illustrating an embodiment of the Path creation process.

FIG. 3 is a block diagram illustrating an embodiment of the Trade Negotiation Process.

FIGS. 4A and 4B are a block diagram illustrating an embodiment of the Quick Scheduling Process.

FIG. 5 is a block diagram illustrating a computer system that may be utilized in the performance of the disclosed system and methods/processes.

### DETAILED DESCRIPTION OF THE INVENTION

While this invention may be embodied in many forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

In general, this disclosure is directed to systems and methods that provide an integrated approach for energy trading, transmission management and scheduling within a single framework. Using the techniques of this disclosure, every stakeholder with a need or desire to buy or sell electrical energy and/or electrical grid transmission capability for any such purchased or already owned or generated electrical energy, is an active market participant and/or decision maker in the information process. Whether stakeholder's interest is financial or the reliable operation of the Bulk Electric System, the herein described integrated information process is a technology enabler for these parties to interact and work on consistent information available within a single process or method, facilitating both ease of comparison in making decisions that best fit their business interests and ease of scheduling purchased energy for transmission. The systems and methods are sometimes referred to generally as “webExchange” through this disclosure.

In terms of organization, this disclosure first describes the webExchange module. The disclosure then describes the various submodules that form the webExchange module, including the Trade Negotiation process 106, which, in accordance with various techniques of this disclosure, is responsible for facilitating market interactions for electrical energy amongst stakeholders en route to establishing confirmed deals. The disclosure then describes an embodiment of the Path Creation Process 107, followed by the Quick Scheduling Process 109, which in accordance with various techniques of this disclosure, is responsible for compilation and selection of transmission capabilities to facilitate single party scheduling of electrical energy for distribution to the Bulk Electric System.

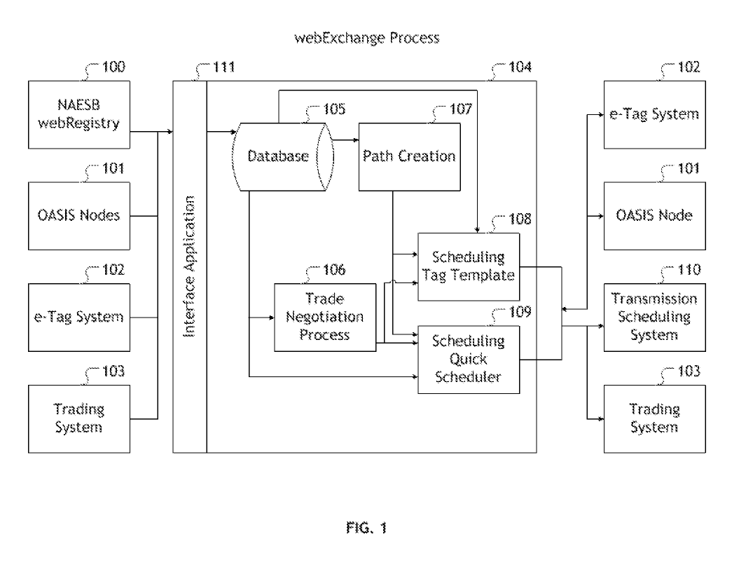

Referring now to FIG. 1, in one particular embodiment of the invention, the inventive system or method 104, may receive input data. Sources of input data comprise of the North American Energy Standards Board (NAESB) Energy Information Registry (“webRegistry”) 100, Open Access Same time Information System (OASIS) nodes 101, an electronic tagging (“e-Tag”) system 102, and a trading system 103. In embodiments of the disclosure utilizing computer software programming, these inputs are written to a database 105. Inputs are then sent to and received by a Trade Negotiation Process 106, a Path Creation Process 107, and a Scheduling Process 108/109. The inventive system or method may then result in the transmission of various data to e-tag systems 102, OASIS nodes 101, Trading systems 103, and/or other Transmission Scheduling systems 110.

All of the data inputs for the invention are available from various interface applications 111 as indicated in FIG. 1. Any such application interface 111 known in the art can be implemented so long as the relevant data inputs, as exemplified by the below list, are consistently and reliably delivered into the system or method as described at a rate sufficient to meet trading, scheduling, and transmission user demands.

In one particular embodiment, NAESB webRegistry 100 input data is comprised of registry data, which is generally described as lists of energy industry participants, transmission grid points, and point adjacencies.

In one particular embodiment, OASIS Node 101 input data is comprised of:
OASIS registry data;
ATC prices;
ATC offerings;
Transmission portfolio data, and
TSR data feeds.

In one particular embodiment, NAESB webRegistry 100 input data is comprised of E-Tag System 102, is comprised of
E-Tag feeds, and
E-Tag templates.
   E-Tag templates are modifiable outlines comprised of the necessary parameters of an electronic tag as required by regulatory standards.

In one particular embodiment, Trading System 103 input data is comprised of deal automation templates. Deal automation templates are modifiable outlines comprised of the necessary parameters of for creating a deal between two counterparties for the purchase and/or sale of energy or energy capacity, which may include an electronic tag.

In one particular embodiment, the invention may take the form of a computer program 104 comprised of a database 105 where all the available input data is written onto. The database 105 is accessed by a module for facilitating a Trade Negotiation Process 106, a Path Creation Process 107 and a Scheduling process 108/109. The computer program then comprises of a means for communicating resulting deal and scheduling information to other systems, such as but not necessarily limited to E-tag Systems 102, OASIS Nodes 101, Trading Systems 103, and Transmission Scheduling Systems 110, among others, via appropriate interfaces or services known in the art.

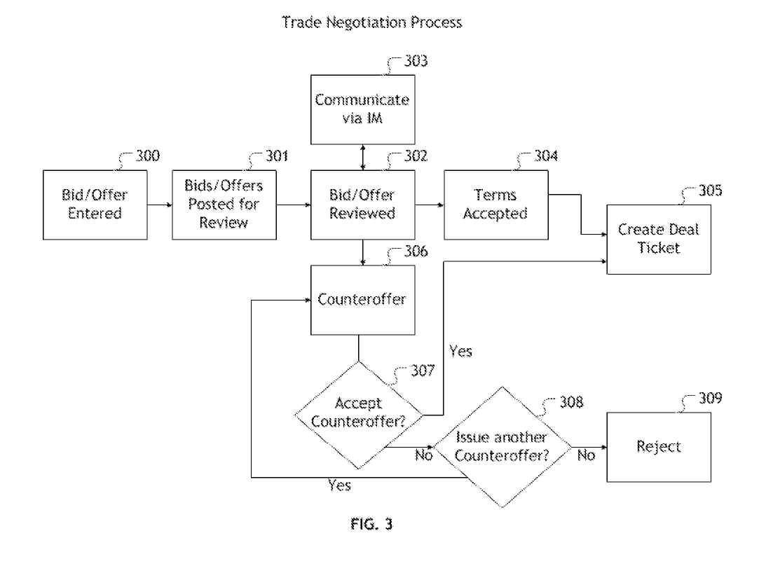

Turning now to FIG. 3, the invention facilitates direct trade actions on posted bids and offers. In one particular embodiment, Bids/Offers are entered 300 into the system by a user. In one particular embodiment, a bid entry may be comprised of identifying product class (as energy or capacity), product type, location, pricing, start/stop time, e-tag energy product and may also indicate whether or not the bid is negotiable. In one particular embodiment, an offer entry may be comprised of identifying product class (as energy or capacity), product type, location, pricing, start/stop time, e-tag energy product and may also indicate whether or not the bid is negotiable. Entered bids/offers 300 are then posted for counter parties to review 301. In one particular embodiment, the posted bids/offers 301 are made available in a summary list with only an amount of detail displayed necessary for identification purposes. Prospective counterparties are then able to select a specific bid/offer for review 302. Upon such selection for review 302, in one particular embodiment, a counter party is then presented with all available details associated with the specific bid/offer are made available.

In some embodiments, the invention may then facilitate an optional opportunity for counterparties to communicate with each other via instant messaging. An observing party may initiate communication anonymously with a posting party for the purposes of discussing a posted bid or offer of interest. The purpose of the trade-related session is for parties to perform an exchange of information prior to trade execution. A preferred embodiment of this functionality occurs within a computer program and presents a communication initialization trigger within a bid/offer detail display, such that a user performing the initialization action will trigger an instant message communication to the posting party associated with the particular bid/post of interest. Moreover, such instant message communication is then permanently associated with the posted bid or offer. If a deal is consummated between the parties, the instant message session will then be linked to that deal and retained in system memory as an associated deal component. Users of the system will be able to view all instant message communications that were conducted in the process of completing any specific deal transaction. Such instant messaging functionality can be accomplished utilizing any instant message communication protocol known in the art, so long as the method chosen can support communication between two entities while maintaining the anonymity of the parties from each other.

After reviewing the details of a bid/offer 302, an observing party may accept the terms of the bid/offer 304 outright. In one particular embodiment, such acceptance 304 may be indicated by selection of an accept button on a bid/offer detail display. Upon acceptance of a bid/offer, the Trade Negotiation Process then completes by creating a Deal Ticket 305 and partially filling in detail. Should the transaction be consummated, the identities of both parties are then revealed to enable the parties to continue effective communication during a transition path selection and scheduling phase.

In one particular embodiment, an observing party may attempt to negotiate the terms of a posted bid/offer by creating and submitting a formal counter offer 306. The counteroffer 306 is then communicated to the posting party for review and consideration 307. If the counteroffer is accepted, the Trade Negotiation Process then completes by creating a Deal Ticket 305 and partially filling in detail. If the counteroffer is not accepted, the posting party chooses whether or not to create another counteroffer 308. If the posting party chooses not to issue another counteroffer, the original counteroffer is rejected 309, with such rejection 309 communicated to the party that had proposed it. If the posting party chooses to issue another counter offer, the counter offer is communicated 308 to the counter party for their review 307. Counteroffers continue to be submitted and reviewed until a deal is reached or rejection made without a subsequent counteroffer made 309. Proposals can continue to be made until a bid/offer's end date is in the past.

In one particular embodiment of the invention, tradable products are able to be defined at will. The system may facilitate the creation of a product type, comprised of a product type name, product type class (for example, energy or capacity), indication of whether or not the product is active, and a description of the product. These product types may then be saved into the system for later use in posting bids/offers.

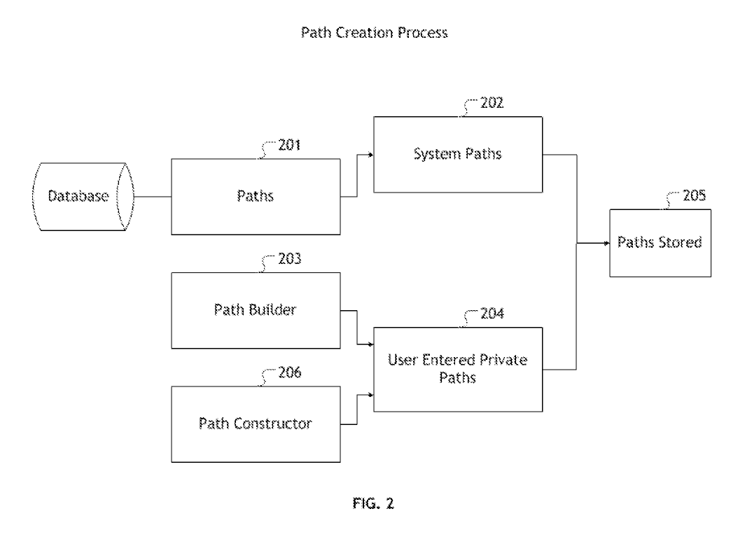

Turning now to FIG. 2, the concept of pre-built paths is central to enabling the high efficiency scheduling and transmission operations of the invention. Once a set of paths has been contracted, such set of paths can be quickly evaluated in the system without requiring a path to be built or rebuilt each time a schedule is constructed. In one particular embodiment, the invention provides two sets of paths, private and public. Private paths are constructed by users and stored in an individual path portfolio associated with the creating user. All available paths are automatically examined by the system to quickly provide various transmission or scheduling services.

In a particular embodiment, the invention allows users to manually enter and define private paths 204. Private paths 204 may be created and stored in the system by users for exclusive use by their companies. These private paths 204 reflect the existing business practices and represent the combined user experience in conducting a user's routine business and are comprised of registry data, OASIS registry data, however, in some embodiments of the invention, private paths may be created independently of a known adjacency upon a user's preference.

In a particular embodiment, a path builder function 203 may facilitate the entry and recordation of private path 204 data within the system using the topological model of the bulk electric system. After an initial POR point is selected for the specific transmission provider, the system will display all paths imported from OASIS that originate from that POR. Once the selection of a path is made, each segment of the path is added to the complete path. Using the POD-POR connectivity data, also known as POR/POD adjacency data, the path builder function 203 displays all path segments connected to the POD point of the selected path, thus presenting branching opportunities.

For each possible path segment users may, in a further particular embodiment of the invention, query for ATC data, price, and their existing transmission position prior to choosing the preferred path segment. Once a selection is made, the new path segment is added to the one selected previously. The process will continue until a complete path is constructed. To complete the path, the ultimate source or sink, depending on which portion of the trade path there are responsible for, as identified from webRegistry registry data must be selected. The system may permit for the removal of recently selected segments in order to “backtrack” one or more steps back and facilitate branching out in a different direction or even starting over from the initial POR point in order to construct a path to suit a particular need or desire. The created private path 204 can be saved in the user's path portfolio for future use.

In another particular embodiment, a path constructor function 206 may facilitate an alternative operation to create and record private path 204 data within the system. Using a path constructor function 206, users can create a private path 204 by assembling path segments on their own without restrictions facilitated by any means known in the art. The created private path 204 is validated for adjacency only at the point of entry into the system. Such a path constructor function 206 will allow users to create private paths but will not support the ATC/price discovery and cannot be used to evaluate bids and offers posted in the system, however, in some embodiments, a path constructor function 206, may indicate whether ATC/Price along a user selected path had at one time been known to exist based upon whether or not the system has information from the OASIS node showing previous ATC/Price had existed along the same user selected path. In some embodiments, a path constructor function 206, may indicate whether the user could procure a TSR along a user selected path based upon whether or not the system has information from the OASIS node showing a previous TSR had existed along the same user selected path.

Public paths are also referred to as system paths. System paths are inputs into the system and can be received from any system path generation source known in the art, including but not necessarily limited to those system paths generated by the Route Builder software of Open Access Technology International, Incorporated. Such system path data is a large set of paths numbering, potentially numbering in the millions, which represent all possible way users can flow energy from any source to any sink point in the Bulk Electric System. System users can supplement their defined private paths by importing public paths into the system to enhance the pool of paths available for analysis, likely at the expense of additional processing time.

In a particular embodiment, the Path Creation Process 107 receives inputs from the database 105 comprised of webRegistry registry data, OASIS registry data Tag templates and deal automation templates. Historical OASIS TSR data may be combined with e-tag data to create system generated system paths 202, however in some embodiments of the invention, system generated system paths 202 may be a direct input from an OASIS Node 101. System paths are generated by importing the transmission provider segment and segment adjacency data the OASIS data downloaded from OASIS provider nodes. For each POR/POD pair, the system will import a defined number of paths and then consider all available path options for selection, beginning with the shortest by segment count. The total number of paths can be quite large and may be controlled by a maximum number of segments allowed in a path, as well as by an overall path count limit as pre-defined within the system. The list of path options presented for selection by a user of the system may then be further limited through use of data filters known in the art or sorted according to a path characteristic. This list of system paths can be updated from time to time by re-executing the generation process to include newly entered service points. The end result of this function is the selection of a path from a list of automatically generated possibilities.

Private paths 203 are combined with System paths 202 to result in a list of all stored paths 204 available for scheduling.

In one particular embodiment, the invention may combine both transmission and scheduling paths into a unique composite path model. Transmission and scheduling paths for the same schedule are often similar but may not be identical. This subtle difference may have an impact on how transmission services are obtained and how an e-Tag is constructed for a given schedule. When transmission services are requested (ATC quote or TSR creation), the transmission side of the path is examined. When a tag needs to be built, the scheduling side of the path model provides the required information to facilitate the construction of an e-tag, therefore streamlining the process and reducing the number of manual steps required to complete transmission and scheduling contracts.

The concept of a global service creates a level of abstraction from individual provider tariffs and is one of the efficiency drivers in the system.

Transmission providers offer various service types on OASIS nodes to their customers. QuickScheduler can generate a number of potential paths for a webExchange transaction that can contain transmission service from various providers and need to know for which provider services it is expected to obtain ATC quotes.

In one particular embodiment of the invention, and in order not to force users to specify transmission provider services each time they run the QuickScheduler Process 109, the invention may allow users to associate a set of provider service types with a single name, referred to herein as a global service. This functionality may facilitate the creation of a single multi-OASIS profile with linked services for individual transmission providers. The system saves such global service definitions into memory in order to use them later to quickly and efficiently perform transmission actions that involve multi-segment paths.

When creating a global service, users may specify two services for each transmission provider, the main service, and the backup service. In addition, they can link a separate service for procurement action.

When using QuickScheduler Process 109, users select the global service to be used for quoting ATCs. The system will obtain the ATC value for each segment in each QuickScheduler path using the individual provider services defined in the global service. If the main service ATC is sufficient to cover the transaction's MW profile, it will be shown on the display. If the main service ATC is insufficient, webExchange will automatically obtain the backup service ATC and will use it instead.

The invention may support collaborative scheduling after a deal is made. Each part to the energy transaction has a pre-defined path to the transaction point prior to the blind bid negotiations for offers/bids. Upon reaching a deal for a bid/offer, buyer and seller can be jointly made responsible for scheduling responsibility. In this embodiment, the system allows the selling party to schedule the portion of the energy transmission from a source point to the trading point; and the buyer to schedule the portion of the energy transmission from trading point to a desired sink point. Parties may select transmission paths for their portion of the total path using any of the above referenced methods. After transmission has been secured by each party and indicates as much within the system, the invention then combines the two separate paths to build a single e-tag for the entire energy schedule, suitable for delivery to an e-tag system through any communication protocol known in the art.

After the completion of the Trade Negotiation Process, 106 and the entry of all available paths through the Path Creation Process 107, a schedule must be created. Schedules may be created utilizing any number of methods novel or known in the art, including but not necessarily limited to, generation of tags based on existing e-tag templates 108 as imported. In a preferred and novel embodiment, the invention utilizes a QuickScheduler Process 109. The QuickScheduler Process 109 received inputs from the database 105, Trade Negotiation Process 106, and Path Creation Process 107. The QuickScheduler Process 109 will first use the user private paths 204 in an attempt to path a transaction. For each segment in a private path 204, ATC and transmission price will be provided from database 105. Paths may also be matched with any existing transmission positions of a user's scheduling entity for a designated provider service, as they may be recorded in an OASIS node, through pre-association of a system user with their scheduling entity and comparing that scheduling entity against OASIS node data.

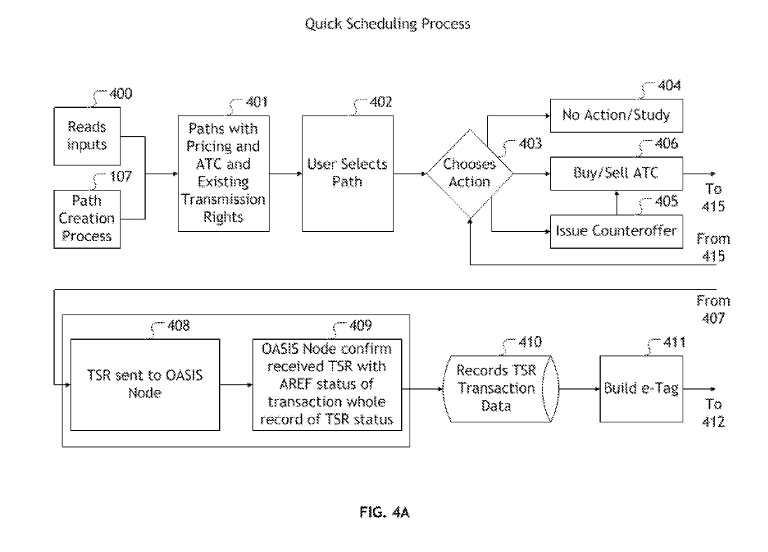

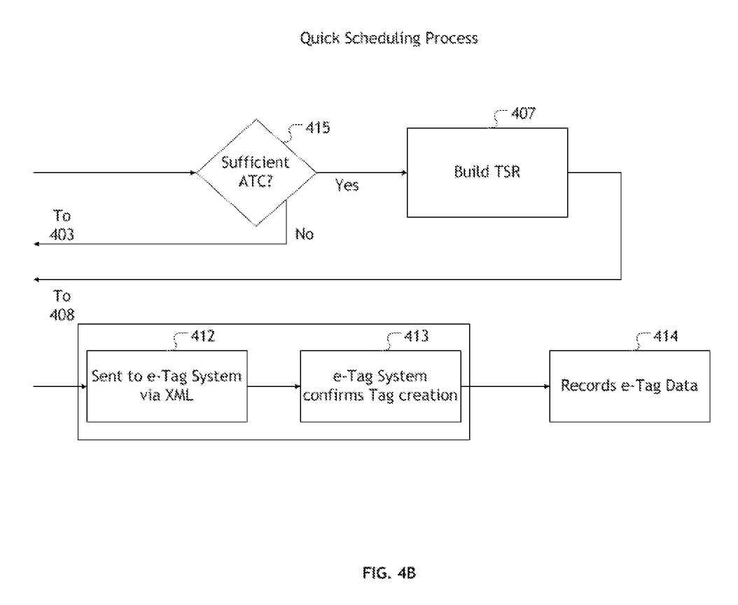

Turning now to FIG. 4, after a user selects a path 402 with sufficient ATC, actions may be taken 403 which mirror the available actions in an OASIS node; namely buy, sell, or counteroffer. If a user has insufficient existing transmission capacity along the selected route, the user may perform no action (or study/evaluate the path and available ATC) 404, buy (or sell) ATC 406 if the ATC is determined to be a reasonable cost (price), or counteroffer 405 the existing price of the available ATC. Such actions are transmitted to an OASIS node for the negotiation and purchase of ATC by creating and submitting a Transmission Service Request (TSR). Upon completion of an action, the system may validate 415 to ensure sufficient ATC has been acquired along all segments of the path. If sufficient ATC has not been acquired, the user must select another action 403 to proceed. A Transmission Service Request (TSR) 407 will be created to secure additional ATC as needed. The TSR is then sent 408 to an OASIS node 101 via any communication protocol known in the art, including but not necessarily limited to XML or SMTP. The OASIS node 101 responds to the TSR submittal 408 by responding with a confirmation 409 comprised of the recorded an AREF number, status of the transaction, and whole record of the TSR transaction, among other possible data as well. The system records 410 this information and uses it to automatically build a compliant E-tag 411 for scheduling transmission to utilize the now purchased transmission rights. All data required for the e-tag along with its transmission and profile structure is encoded in the selected path model. The completed and compliant e-tag is then sent 412 to an e-tag system 102 and transmission scheduling system 110 via any communication protocol known in the art, including but not necessarily limited to XML. The e-tag system 102 responds to the e-tag submittal 412 by responding with a confirmation or error message 413 as appropriate. The system then records such e-tag data 414.

In a particular embodiment, the QuickScheduler Process 109 may be configured to accept any data at any time in order to facilitate a “study-mode.” Using the QuickScheduler Process 109 for a study-mode, a trader can analyze the transmission and commercial viability of bids and offers posted to the system by performing a comparative analysis of several posted alternatives in a reasonable amount of time in order to make an optimal selection.

As a non-limiting example of a potential use for the QuickScheduler Process 109 in the evaluation of bids/offers, a buyer searching for power can import a posted offer into the QuickScheduler Process 109 and quickly check it against an available set of paths. If the user finds a path that has sufficient ATC and reasonable transmission cost or where buyer already owns transmission rights, a user can enter into a trade with high degree of confidence that the transaction can be scheduled. A simple click on an offer can then complete a trade. The selected path can be attached to the trade as the downstream portion, for which the buyer is responsible.

In a particular embodiment, the system may provide for further automation of scheduling. The system may alternatively offer a scheduling functionality that automatically selects all available private paths that meet the topological requirements of the pathed transaction, although such selected paths may not be the best available or most economical. In this embodiment, paths may be selected based on a hierarchy where paths that have sufficient transmission capacity are selected over paths without sufficient transmission capacity. Such scheduling requires little or no user interaction, but may require final approval after paths have been automatically selected and prior to final schedule creation.

In some particular embodiments wherein the invention is comprised of computer software, the invention may further utilize encryption enabling software, such as but not necessarily limited to digital certificates, to secure access to the system and encrypt communications sent to and from the system. Using any number of methods known in the art, the invention may require and validate for the presence of specific encryption enabling software as a login credential. In preferred embodiments, such encryption enabling software is associated on a one-to-one basis with a particular user account. Login to the system of such embodiment would be denied unless the system validates, using any method known in the art, that a user's request to access the system includes the correctly corresponding login credentials comprising of username, password, and encryption enabling software, among others, associated with a particular predefined user account. Moreover, in other embodiments, encryption enabling software may be utilized to encrypt data communications within the invention, such as instant messages, or between the invention and other systems such as but not necessarily limited to e-tag system 102 OASIS notes 101 or others.

Using any method known in the art, encryption enabling software can be incorporated into the invention such that user entered instant messages are encrypted upon sending and then decrypted by the receiving party. As a non-limiting example, in certain embodiments, the invention may comprise of computer software located on a server, which individual users log into over the Internet. In such an example, each user account could be associated with certain encryption enabling software. An instant message sent between a user's computer and the central server would be encrypted during transmission using the sending user's encryption enabling software. The message could then be decrypted using a matching encryption enabling software once the transmission reached the server. The server would then execute internal routing processes to direct the instant message to the intended recipient user, in this particular example, logged into the invention through a different computer over the internet. The central server would encrypt the instant message using the encryption enabling software of the recipient user during communication transmission. Once received, the instant message communication would then be decrypted by the recipient user's encryption enabling software such that the message is understandable to the recipient user.

Moreover, communications between the inventive system/method and other destination systems may also be encrypted with encryption enabling software. Such encryption can be accomplished using any known means available in the art. As a non-limiting example, both the system of the present disclosure and a destination system can be set up with encryption enabling software, such as but not necessarily limited to digital certificates, to facilitate the encryption of communication sent from one system and the subsequent decryption of the information by the recipient system. Such pre-incorporation of encryption enabling software by both the sending system and recipient systems ensures that any intercepted communications cannot be read, thus raising the confidence level of transactions occurring within the system as a whole.

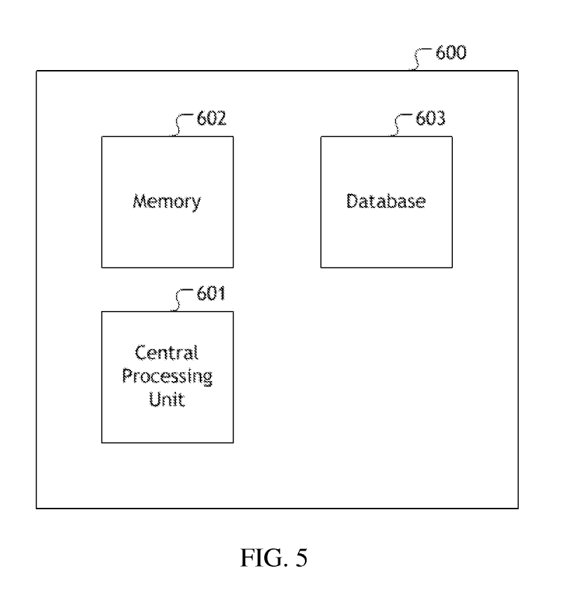

Some or all of the previously discussed embodiments may be performed utilizing a computer or computer system. An example of such a computer or computer system is illustrated in FIG. 5. Computer 600 contains Central Processing Unit 601. Central Processing Unit 601 may perform some or all of the processes involved in the previously discussed embodiments. Central Processing Unit 601 may utilize information contained in Memory 602, Database 603, or both. Central Processing Unit 601 may also write information to Memory 602, Database 603, or both. While in this FIG. 5 only one Computer 600 is shown, some embodiments may make use of multiple computers or computer systems. In some embodiments some of these computers or computer systems may not have dedicated memory or databases, and may utilize memory or databases that are external to the computer or computer system.

The above examples and disclosure are intended to be illustrative and not exhaustive. These examples and description will suggest many variations and alternatives to one of ordinary skill in this art. All of these alternatives and variations are intended to be included within the scope of the claims, where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of written description, any dependent claim which follows should be taken as alternatively written in a multiple dependent form from all claims which possess all antecedents referenced in such dependent claim.

1. A method of trading and scheduling electrical power comprising the steps of:
receiving available transmission capability (ATC) prices and ATC offerings from open access same time information system (OASIS) nodes;
receiving a data feed of transmission service requests (TSRs);
communicating with electronic tagging systems to create electronic tags (e-Tags), facilitating a market for the posting of electrical energy bids and offers amongst a group of entities which facilitates both anonymous discussions of deals between the counterparties and negotiation of deals before proceeding to an agreed upon transaction for electric energy and further,
scheduling for transmission of the electric energy subject to the transaction is then facilitated in an integrated and conveniently straightforward manner along a transmission path as evaluated and then selected by a single party or both parties to the energy transaction.

2. The method of claim 1 further comprising the receiving of
OASIS registry data and
transmission portfolio data from open access same time information system (OASIS) nodes.

3. The method of claim 1 further including the step of receiving input data from one or more of the group consisting of North American Energy Standards Board (NAESB) energy information registry, OASIS nodes, electronic e-Tag system and a trading system.

4. The method of claim 1 wherein the input data is stored in a database.

5. The method of claim 4 wherein the input data is sent to a trade negation process, a path creation process, and a scheduling process.

6. The method of claim 5 further including the step of sending processed data to one or more of the group of system selected from e-tag systems, OASIS nodes, trading systems and transmission scheduling systems.

7. The method of claim 6 wherein the e-tag system is comprised of e-tag feeds and e-tag templates.

8. The method of claim 6 wherein the trading system input data is comprised of deal automation templates.

9. The method of claim 1 wherein the energy bid is comprised of an identifying product class, product type, location, pricing, start and stop time, and e-tag energy product.

10. The method of claim 1 wherein the energy offer is comprised of an identifying product class, product type, location, pricing, start and stop time, and e-tag energy product.

11. The method of claim 5 further including the step of listing bids and offers for viewing and selection by an observing party.

12. The method of claim 11 further including the step of displaying transmission availability and costs along possible paths open for scheduling a proposed bid or offer.

13. The method of claim 11 wherein the observing party may initiate communication anonymously with a listed bid or offer.

14. The method of claim 11 further including the step of the observing party accepting the terms of the bid or offer.

15. The method of claim 13 wherein an accepted bid or offer results in a deal ticket being created.

16. The method of claim 14 further including the step of scheduling the transmission of the accepted bid or offer.

17. The method of claim 11 further including the step of the observing party making a counteroffer as to the terms of the bid or offer.

18. The method of claim 16 wherein an accepted counteroffer results in a deal ticket being created.

19. The method of claim 17 further including the step of scheduling the transmission of the accepted bid or offer.

20. The method of claim 5 further including the step of constructing a path for the transmission of the electrical energy.

21. The method of claim 19 wherein pre-built paths are created and saved in the database.

22. The method of claim 20 wherein the pre-built paths are public.

23. The method of claim 20 wherein the pre-built paths are private.

24. The method of claim 21 further comprising a step wherein paths are associated with a entity's existing rights and/or Available Transmission Capacity price information.

25. The method of claim 24 further comprising a step wherein a path is identified and evaluated for sufficient Available Transmission Capacity.

26. The method of claim 25 further comprising a step wherein options to meet the transmission capacity requirements to support the transmission of all energy from a deal ticket are presented, if insufficient Available Transmission Capacity is available along the identified path.

27. The method of claim 26 wherein options comprise study, buy Available Transmission Capacity, sell Available Transmission Capacity, or issue a counteroffer for the purchase of ATC.

28. The method of claim 26 further comprising a step wherein, if sufficient Available Transmission Capacity is available along the identified path, the details required for the creation of a Transmission Service Reservation are created and logged.

29. The method of claim 28 further comprising a step wherein the logged details required for the creation of a Transmission Service Reservation are sent to an Open Access Same-time Information System (OASIS) node for the creation of a Transmission Service Reservation.

30. The method of claim 29 further comprising a step wherein Transmission Service Reservation details are acquired from the Open Access Same-Time Information System and logged.

31. The method of claim 30 further comprising a step wherein the details required for the creation of an electronic tag are created and logged.

32. The method of claim 31 further comprising a step wherein the logged details required for the creation of an electronic tag are sent to an electronic tagging system for the creation of an electronic tag.

33. The method of claim 32 further comprising a step wherein electronic tag details are acquired from an electronic tagging system and logged.

34. A system of trading and scheduling electrical power comprising:
a computer having a memory and a computer program running in the memory, the computer program configured to:
receive available transmission capability (ATC) prices and ATC offerings from open access same time information system (OASIS) nodes;
receive a data feed of transmission service requests (TSRs);
communicate with electronic tagging systems to create electronic tags (e-Tags), facilitating a market for the posting of electrical energy bids and offers amongst a group of entities which facilitates both anonymous discussions of deals between the counterparties and negotiation of deals before proceeding to an agreed upon transaction for electric energy and further,
schedule for transmission of the electric energy subject to the transaction is then facilitated in an integrated and conveniently straightforward manner along a transmission path as evaluated and then selected by a single party or both parties to the energy transaction.
